(19) United States
(12) Patent Application Publication
(10) Pub. No.: US 2025/0220121 A1
(43) Pub. Date: Jul. 3, 2025

(54) INFORMATION PROCESSING SYSTEM AND NON-TRANSITORY COMPUTER-READABLE RECORDING MEDIUM

(71) Applicant: FUJIFILM Business Innovation Corp., Tokyo (JP)

(72) Inventor: Masaru YOKOTA, Kanagawa (JP)

(73) Assignee: FUJIFILM Business Innovation Corp., Tokyo (JP)

(21) Appl. No.: 18/746,077

(22) Filed: Jun. 18, 2024

(30) Foreign Application Priority Data
Dec. 28, 2023 (JP) 2023-222283

(51) Int. Cl. H04N 1/00; G06T 7/00

(52) U.S. Cl. CPC H04N 1/00013; G06T 7/0008; H04N 1/00029; G06T 2207/30144

(57) ABSTRACT

An information processing system includes one or a plurality of processors, wherein the one or the plurality of processors acquires a read image that is an image obtained by reading, by a reading section, a diagnosis image of a recording medium output by an image forming section, when the read image has an image abnormality as a result of diagnosis of the read image acquired, displays a cause of the image abnormality in association with the image abnormality, and outputs presence of another image abnormality having the cause being common when at least one of the image abnormality displayed or the cause of the image abnormality is designated by a user.

### CROSS-REFERENCE TO RELATED APPLICATIONS

This application is based on and claims priority under 35 USC 119 from Japanese Patent Application No. 2023-222283 filed Dec. 28, 2023.

### BACKGROUND

### (i) Technical Field

The present invention relates to an information processing system and a non-transitory computer-readable recording medium.

### (ii) Related Art

For example, JP2003-256836A discloses a configuration in which a region of interest is selected in an image, an image region is automatically moved to the left or right while maintaining the region of interest when a zoom level is changed, the selected region of interest is maintained, and if there is a plurality of regions of interest, the number of regions of interest is optimized for display.

### SUMMARY

A diagnosis image of a recording medium is output by an image forming section, the output diagnosis image is read by a reading section, and when there is an image abnormality in the read image as a result of the diagnosis of the read image which has been read, a cause of the image abnormality is identified. A user can know the presence of the image abnormality and the cause of the image abnormality by viewing a screen displaying a diagnosis result. The user takes countermeasures such as component replacement according to the cause of the image abnormality to prevent the image abnormality from occurring.

However, in a mode in which the cause of an image abnormality is displayed only in association with the image abnormality, it may be difficult for some users to determine whether the cause is reliable.

Aspects of non-limiting embodiments of the present disclosure relate to an information processing system that obtains, from a user who has viewed a diagnosis result, higher reliability about a cause of an image abnormality than in a case where the diagnosis result of a read image is displayed only in such a manner that the cause is associated with the image abnormality.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising one or a plurality of processors, wherein the one or the plurality of processors acquires a read image that is an image obtained by reading, by a reading section, a diagnosis image of a recording medium output by an image forming section, when the read image has an image abnormality as a result of diagnosis of the read image acquired, displays a cause of the image abnormality in association with the image abnormality, and outputs presence of another image abnormality having the cause being common when at least one of the image abnormality displayed or the cause of the image abnormality is designated by a user.

### BRIEF DESCRIPTION OF THE DRAWINGS

Exemplary embodiments of the present invention will be described in detail based on the following figures, wherein:

FIG. 1 is a diagram illustrating an example of a diagnosis system;

FIG. 2 is a diagram illustrating an example of a hardware configuration of an information processing unit provided in a server apparatus and an image forming apparatus;

FIG. 3 is a diagram illustrating the image forming apparatus;

FIG. 4 is a diagram illustrating an example of a configuration in which an image is formed on paper in the image forming apparatus;

FIGS. 5A and 5B are tables describing a method of identifying a cause of an image abnormality, FIG. 5A illustrates various image forming conditions when a chart paper is generated, and FIG. 5B illustrates the identified causes;

FIG. 6 is a block diagram illustrating a functional configuration of a CPU provided in the server apparatus;

FIGS. 7A to 7C are diagrams for describing processing by a diagnosis result acquirer, FIG. 7A illustrates a read image, FIG. 7B illustrates an averaged brightness profile, and FIG. 7C illustrates a diagnosis result;

FIGS. 8A and 8B are diagrams for describing display on a display device of a user terminal according to a first exemplary embodiment, FIG. 8A illustrates a case where a result display screen is displayed on the display device, and FIG. 8B illustrates a case where a notification screen is displayed on the display device;

FIGS. 9A and 9B are diagrams for describing display on the display device of the user terminal according to a second exemplary embodiment, FIG. 9A illustrates a case where the result display screen is displayed on the display device, and FIG. 9B illustrates a case where the notification screen is displayed on the display device;

FIGS. 10A and 10B are diagrams for describing display on the display device of the user terminal according to a third exemplary embodiment, FIG. 10A illustrates a case where the result display screen is displayed on the display device, and FIG. 10B illustrates a case where the notification screen is displayed on the display device;

FIG. 11 is a diagram for describing a notification screen that notifies more detailed contents than the notification screen in FIG. 10B;

FIGS. 12A and 12B are diagrams for describing display on the display device of the user terminal according to a fourth exemplary embodiment, FIG. 12A illustrates a case where the result display screen is displayed on the display device, and FIG. 12B illustrates a case where the notification screen is displayed on the display device;

FIGS. 13A and 13B are diagrams illustrating pre-processing, FIG. 13A illustrates an example of a flowchart of processing of creating a contrast table as the pre-processing, and FIG. 13B illustrates an example of the contrast table; and

FIGS. 14A to 14D are diagrams illustrating display processing, FIG. 14A is an example of a flowchart of the display processing, and FIGS. 14B to 14D illustrate information acquired or selected in steps in FIG. 14A.

### DETAILED DESCRIPTION

In the following, exemplary embodiments of the present invention will be described with reference to the drawings.

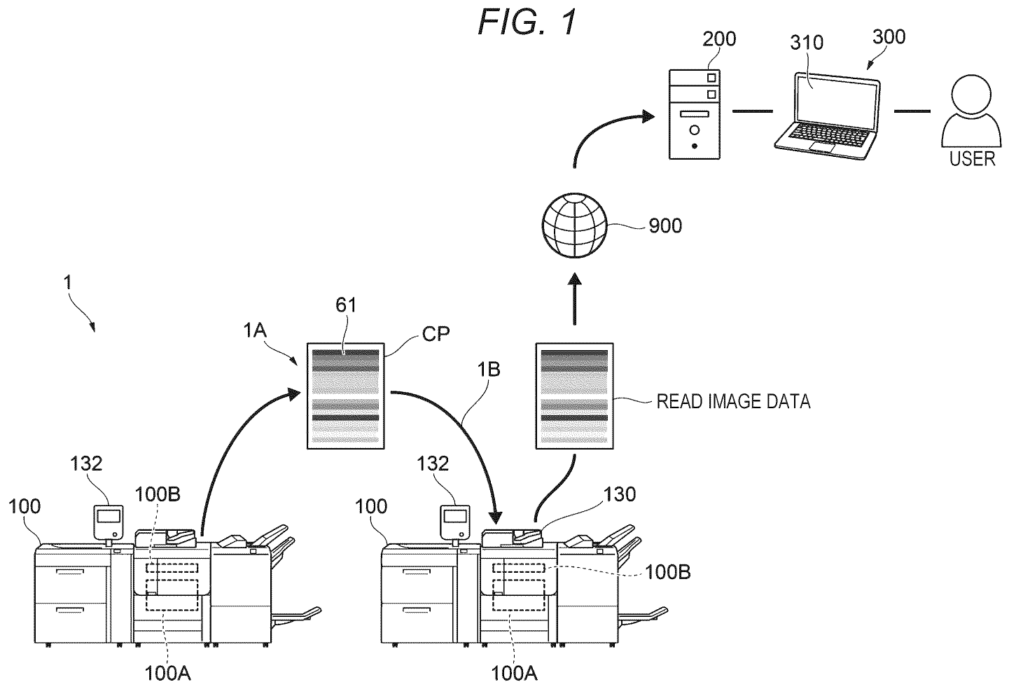

FIG. 1 is a diagram illustrating an example of a diagnosis system 1.

The diagnosis system 1 according to the present exemplary embodiment is provided with a plurality of image forming apparatuses 100 and a server apparatuses 200 connected to each of the plurality of image forming apparatuses 100 via a communication line 900. In the present exemplary embodiment, diagnosis of each of the image forming apparatuses 100 is performed in the server apparatus 200 as an example of an information processing system and an example of an information processing apparatus.

Furthermore, the diagnosis system 1 according to the present exemplary embodiment is provided with a user terminal 300 that is connected to the server apparatus 200 and receives an operation from a user.

Note that FIG. 1 illustrates two image forming apparatuses 100 of the plurality of image forming apparatuses 100.

The user terminal 300 is provided with a display device 310. The user terminal 300 is implemented by a computer. Examples of the form of the user terminal 300 include a personal computer (PC), a smartphone, and a tablet terminal.

The image forming apparatus 100 is provided with an image former 100A as an example of an image forming section that forms an image on paper as an example of a recording medium.

An image is formed on paper by the image former 100A by using, for example, an inkjet method or an electrophotographic method. The method of forming an image on paper by the image former 100A is not limited to the inkjet method or the electrophotographic method, and another method may be used.

The image forming apparatus 100 is further provided with an information processing unit 100B. The information processing unit 100B performs various kinds of processing to be performed on the image forming apparatus 100.

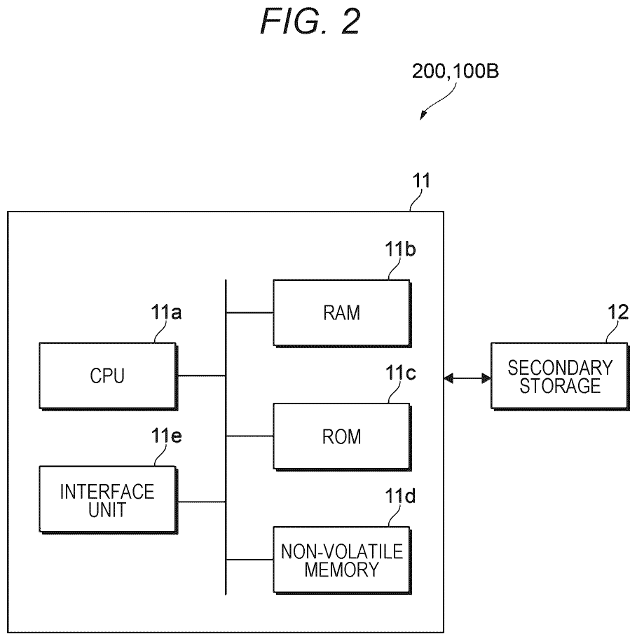

FIG. 2 is a diagram illustrating an example of a hardware configuration of the information processing unit 100B provided in the server apparatus 200 and the image forming apparatus 100. The information processing unit 100B provided in the server apparatus 200 and the image forming apparatus 100 is implemented by a computer.

Each of the server apparatus 200 and the information processing unit 100B includes a calculation processing unit 11 that executes digital calculation processing in accordance with a program and a secondary storage 12 that stores information.

The secondary storage 12 is implemented by an existing information storage device such as, for example, a hard disk drive (HDD), a semiconductor memory, or a magnetic tape. The calculation processing unit 11 includes a CPU 11a as an example of a processor.

The calculation processing unit 11 is provided with a RAM 11b used as a working memory or the like of the CPU 11a and a ROM 11c in which a program or the like to be executed by the CPU 11a is stored.

The calculation processing unit 11 is provided with a non-volatile memory 11d that is configured to be rewritable and can hold data even when power supply is stopped, and an interface unit 11e that controls each unit such as a communication unit connected to the calculation processing unit 11.

The non-volatile memory 11d includes, for example, a battery-backed SRAM, a flash memory, or the like. The secondary storage 12 stores, in addition to files and the like, programs to be executed by the calculation processing unit 11.

In the present exemplary embodiment, the calculation processing unit 11 reads a program stored in the ROM 11c or the secondary storage 12 to execute each processing.

The program executed by the CPU 11a can be provided to the server apparatus 200 and the information processing unit 100B in a state of being stored in a computer-readable recording medium such as a magnetic recording medium (magnetic tape, magnetic disk, or the like), an optical recording medium (optical disc or the like), a magneto-optical recording medium, or a semiconductor memory. The program executed by the CPU 11a may be provided to the server apparatus 200 and the information processing unit 100B by using a communication unit such as the Internet.

As used in the specification, a processor refers to a processor in a broad sense, and includes a general-purpose processor (for example, central processing unit (CPU) and the like) and a dedicated processor (for example, graphics processing unit (GPU), application specific integrated circuit (ASIC), field programmable gate array (FPGA), programmable logic devices, and the like).

The operation of the processor may be performed not only by one processor but also by a plurality of processors existing at physically distant positions in cooperation with each other. The order of the operations of the processor is not limited to only the order described in the present exemplary embodiment and may be changed.

Of the processing described below, the processing performed by the image forming apparatus 100 is performed by the CPU 11a as an example of a processor provided in the image forming apparatus 100.

Of the processing described below, the processing performed by the server apparatus 200 is performed by the CPU 11a as an example of a processor provided in the server apparatus 200.

In the processing described below, the server apparatus 200 as an example of an information processing system performs processing for diagnosis of the image forming apparatus 100. The information processing system that performs processing for diagnosis of the image forming apparatus 100 may be implemented by one apparatus such as one server apparatus 200 or may be implemented by a plurality of apparatuses.

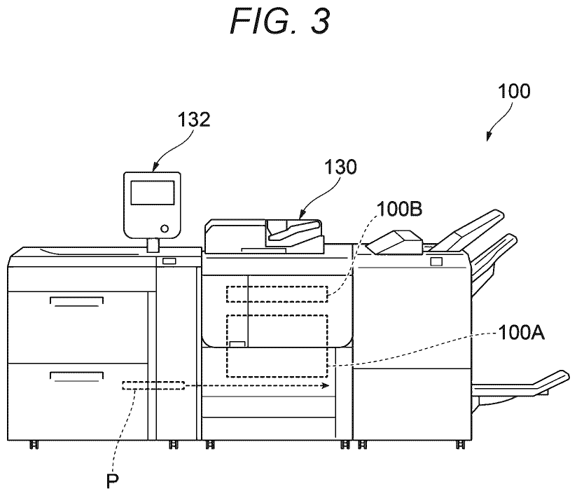

FIG. 3 is a diagram illustrating the image forming apparatus 100.

In the present exemplary embodiment, as described above, the image forming apparatus 100 is provided with the image former 100A that forms an image on paper P that is an example of a recording medium.

In the present exemplary embodiment, when passing through the image former 100A, the paper P passes through the image former 100A with one side of the paper P facing the image former 100A.

The image forming apparatus 100 is also provided with an image reading device 130 as an example of an image reading section that reads an image formed on a recording medium such as the paper P.

The image reading device 130 is a so-called scanner having a function of conveying the paper P. The image reading device 130 includes a light source that emits light to be applied to the paper P, and a light receiver such as a CCD that receives reflected light from the paper P. In the present exemplary embodiment, read image data, which will be described later, is generated on the basis of the reflected light received by the light receiver.

In the image reading device 130, an image reading position is set in advance, and the image reading device 130 reads an image of a part of the sequentially transported paper P positioned at the reading position.

The image forming apparatus 100 also has an information transmission function of transmitting information to the server apparatus 200 (see FIG. 1).

In an example illustrated in FIG. 3, the image reading device 130 is provided in an upper part of the image forming apparatus 100. The image reading device 130 sequentially reads paper (not illustrated) set by the user. The paper is not limited to paper on which an image has been formed by the image forming apparatus 100 but may be paper on which an image has been formed by another image forming apparatus.

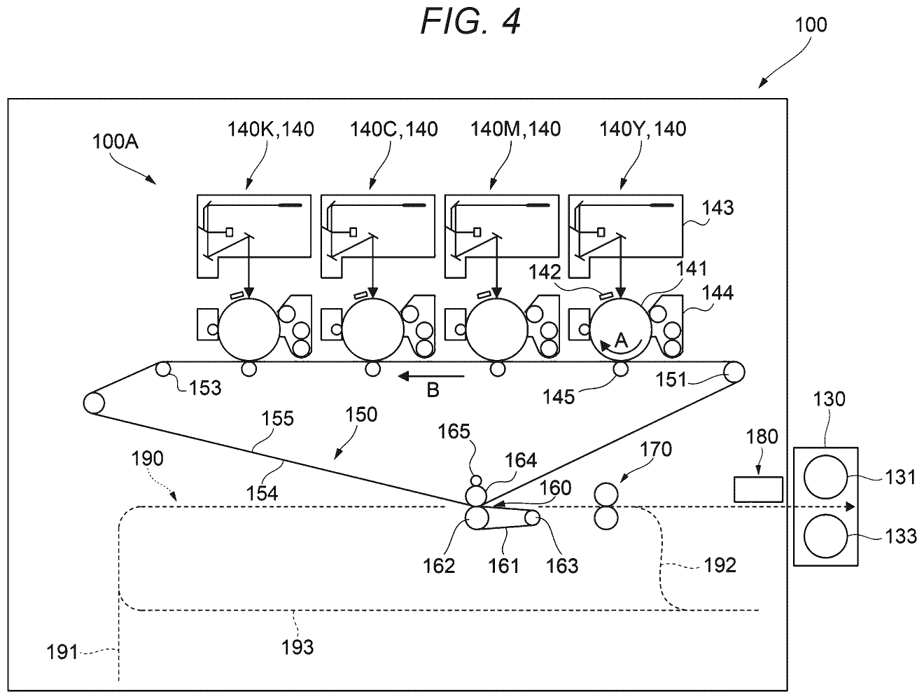

An installation mode of the image reading device 130 is not limited to the mode illustrated in FIG. 3, and the image reading device 130 may be provided inside the image forming apparatus 100 and on a conveyance path of the paper P (see FIG. 4).

In this case, the paper P on which the image is formed by the image former 100A sequentially passes through the image reading device 130, and during this passage, each image on the paper P is sequentially read.

In the present exemplary embodiment, the image reading device 130 is provided with a paper reversing mechanism, so that the reversed paper can be supplied to the image reading position.

Accordingly, in the present exemplary embodiment, the paper whose image formed on one side has been read can be reversed and supplied to the reading position again, so that the images on front and back sides of the paper can be read.

In addition, in reading the image of the paper, the paper may be placed on a document table (not illustrated) including plate-shaped glass or the like, and the paper placed on the document table may be read.

Furthermore, each of the image forming apparatuses 100 is provided with an operation receiver 132 that receives an operation from the user. The operation receiver 132 is configured by a so-called touch panel. The operation receiver 132 displays information to the user and receives an operation performed by the user.

Note that the display of information to the user and the reception of a user operation are not required to be performed by one operation receiver 132 as in the present exemplary embodiment, and an operation receiver and an information display unit may be provided separately.

In the present exemplary embodiment, when the image forming apparatus 100 (see FIG. 1) is diagnosed, first, the image former 100A is operated to form a chart image 61 on paper. As a result, as indicated by reference numeral 1A, a chart paper CP on which the chart image 61 as an example of a diagnosis image is formed is generated.

The chart image 61 is an image used for diagnosis of the image forming apparatus 100, and in the present exemplary embodiment, the chart paper CP on which the chart image 61 used for the diagnosis is formed is generated.

When the chart paper CP is generated, as indicated by a reference numeral 1B in FIG. 1, the chart paper CP is set in the image reading device 130. Then, the image reading device 130 is used to read the chart paper CP on which the chart image 61 is formed.

Accordingly, read image data obtained by reading the chart paper CP is generated.

In the present exemplary embodiment, the read image data is transmitted to the server apparatus 200 and stored in the server apparatus 200. The server apparatus 200 diagnoses the image forming apparatus 100 on the basis of the read image data.

Then, in the present exemplary embodiment, a user who uses the diagnosis system 1 accordingly to the present exemplary embodiment, such as a maintenance person who performs maintenance of the image forming apparatus 100, accesses the server apparatus 200 and refers to a result of the diagnosis by the server apparatus 200.

Each of the image forming apparatuses 100 generates the chart paper CP and reads the chart paper CP in this manner to generate read image data.

Next, the read image data is transmitted to the server apparatus 200. Then, as described above, in the present exemplary embodiment, the server apparatus 200 diagnoses the image forming apparatus 100.

Diagnosis processing by the server apparatus 200 will be described.

In the present exemplary embodiment, the CPU 11a (see FIG. 2) as an example of a processor provided in the server apparatus 200 diagnoses the image forming apparatus 100 on the basis of the read image data transmitted from the image forming apparatus 100 and acquires a diagnosis result that is a result of the diagnosis.

Specifically, the CPU 11a acquires a diagnosis result that is a result of diagnosing the chart image 61, which is an image formed on the chart paper CP, and that is a diagnosis result for each of a plurality of diagnosis items.

In the present exemplary embodiment, the plurality of diagnosis items is determined in advance, and the CPU 11a of the server apparatus 200 analyzes the chart image 61 included in the read image data, and acquires a diagnosis result for each of the plurality of diagnosis items.

Specifically, the CPU 11a of the server apparatus 200 acquires a diagnosis result for each of the plurality of diagnosis items, for example, on the basis of a difference between a reference value predetermined for each of the plurality of diagnosis items and a value obtained by analyzing the chart image 61.

The CPU 11a of the server apparatus 200 acquires a diagnosis result with a worse evaluation as the difference is greater.

Next, the CPU 11a rearranges a plurality of the obtained diagnosis results so that the plurality of the diagnosis results is arranged in a predetermined order.

Specifically, when rearranging the plurality of diagnosis results, the CPU 11a rearranges the plurality of diagnosis results, for example, so that the plurality of the diagnosis results is arranged in descending order or in ascending order of evaluation.

Thereafter, the CPU 11a generates a screen on which the plurality of diagnosis results is arranged in the predetermined order.

Next, a description will be made of a configuration for, when a diagnosis result indicates that there is a malfunction, distinguishing whether the malfunction is due to the image former 100A (see FIG. 3) that forms an image on paper or due to the image reading device 130 (see FIG. 3) that reads an image on the paper. Such a configuration is implemented by the image reading device 130 and the CPU 11a in the image forming apparatus 100.

FIG. 4 is a diagram illustrating an example of a configuration in which an image is formed on the paper P in the image forming apparatus 100, and illustrates a case of an electrophotographic method.

The image forming apparatus 100 is provided with the image former 100A and a paper conveyor 190. The image reading device 130 is disposed at a paper ejection position of the image forming apparatus 100.

The image former 100A is provided with an image forming unit 140, an intermediate transfer belt 150, a secondary transfer section 160, a fixing device 170, and a post-processing unit 180.

In the present exemplary embodiment, as the image forming units 140, four image forming units 140Y, 140M, 140C, and 140K corresponding to toners of four colors of yellow (Y), magenta (M), cyan (C), and black (K) are provided.

The image forming units 140Y, 140M, 140C, and 140K are aligned in a moving direction of the intermediate transfer belt 150, and form toner images by the electrophotographic method.

Each of the image forming units 140Y, 140M, 140C, and 140K includes a photosensitive drum 141, a charging section 142, an exposure section 143, a development section 144, and a primary transfer section 145.

Each of the image forming units 140Y, 140M, 140C, and 140K forms a toner image in one of the color Y, M, C, or K, and transfers the toner image onto the intermediate transfer belt 150. Accordingly, a toner image in which the toner images of the respective colors of YMCK are superimposed is formed on the intermediate transfer belt 150.

The photosensitive drum 141 rotates in the direction of arrow A at a predetermined speed. An electrostatic latent image is formed on a circumferential surface of the photosensitive drum 141.

The charging section 142 charges the circumferential surface of the photosensitive drum 141 to a predetermined potential.

The exposure section 143 irradiates the charged circumferential surface of the photosensitive drum 141 with light to form an electrostatic latent image on the circumferential surface of the photosensitive drum 141.

The development section 144 attaches toner to the electrostatic latent image formed on the circumferential surface of the photosensitive drum 141 to form a toner image.

The primary transfer section 145 transfers the toner image formed on the circumferential surface of the photosensitive drum 141 onto the intermediate transfer belt 150.

A voltage having a polarity opposite to a charging polarity of the toner is applied to the primary transfer section 145. As a result, the toner images formed on the circumferential surface of the photosensitive drum 141 are sequentially electrostatically attracted onto the intermediate transfer belt 150, and a color toner image in which the toner images overlap each other is formed on the intermediate transfer belt 150.

The intermediate transfer belt 150 is supported by a plurality of roll-shaped members. The intermediate transfer belt 150 is formed in an endless shape and circularly moves in the direction of arrow B. Furthermore, the intermediate transfer belt 150 has an outer peripheral surface 154 and an inner peripheral surface 155.

The intermediate transfer belt 150 is used for conveyance of the toner image. In the present exemplary embodiment, a toner image is formed on the outer peripheral surface 154 of the intermediate transfer belt 150, and the toner image is conveyed to the secondary transfer section 160 by movement of the intermediate transfer belt 150.

In the present exemplary embodiment, a driving roller 151 that is driven by a motor (not illustrated) to drive the intermediate transfer belt 150 is provided as a roll-shaped member disposed inside the intermediate transfer belt 150. In addition, an idle roll 153 that supports the intermediate transfer belt 150 and a backup roll 164 are provided as roll-shaped members.

These roll-shaped members are rotatably provided and pressed against the inner peripheral surface 155 of the intermediate transfer belt 150.

The paper conveyor 190 is provided with a conveyance path 191 that takes out the sheet P from a paper storage portion (not illustrated) and conveys the paper P to the secondary transfer section 160, a reverse path 192 that is branched between the fixing device 170 and the post-processing unit 180 and is for reversing the paper P fixed by the fixing device 170 so that the front and back sides are inverted, and a conveyance path 193 that guides the paper P reversed by the reverse path 192 to the conveyance path 191.

In double-sided printing, the paper is conveyed by the reverse path 192 and the conveyance path 193.

The conveyance path 191 is formed so that the paper P fixed by the fixing device 170 is conveyed to the post-processing unit 180 and then ejected from the image forming apparatus 100. The paper P ejected from the image forming apparatus 100 passes through the image reading device 130.

The post-processing unit 180 referred to herein is a device that performs, for example, processing of binding paper bundle, processing of folding paper, processing of cutting paper, processing of bookbinding, and the like. Note that the chart paper CP is ejected without being subjected to the post-processing, and the chart image 61 (see, for example, FIG. 1) is read by the image reading device 130.

The image reading device 130 includes a reader 131 positioned on an upper side of a region through which paper passes and a reader 133 positioned on a lower side. In single-sided printing, the image is read by the upper reader 131, and in double-sided printing, the images on both sides are read at once by the upper reader 131 and the lower reader 133.

The secondary transfer section 160 includes a secondary transfer conveyance belt 161 disposed in contact with the outer peripheral surface 154 of the intermediate transfer belt 150. The secondary transfer conveyance belt 161 is a semiconductive endless annular belt stretched between a driving roll (transfer roll) 162 including metal such as SUS, for example, and a driven roll 163 including, for example, a rubber roll. The secondary transfer conveyance belt 161 is conveyed at a predetermined speed by the driving roll 162, and is given a predetermined tension by the driving roll 162 and the driven roll 163.

The secondary transfer section 160 is also provided with a backup roll 164 that is disposed on the inner peripheral surface 155 of the intermediate transfer belt 150 and constitutes a counter electrode of the secondary transfer conveyance belt 161, and a power feeding roll 165 including metal that applies a secondary transfer bias to the backup roll 164.

The secondary transfer section 160 configured as described above transfers the toner image conveyed to the secondary transfer section 160 by the intermediate transfer belt 150 onto the conveyed paper P.

The fixing device 170 is disposed downstream of the secondary transfer section 160 in a conveyance direction of the paper P. The fixing device 170 is provided with a fixing roll having a heat source and a pressure roll provided as to face the fixing roll. The fixing device 170 fuses an unfixed toner image on the paper P to fix the toner image onto the paper P. As a result, an image including the toner image is formed on the paper P.

Next, a method of identifying a cause of an image abnormality will be described.

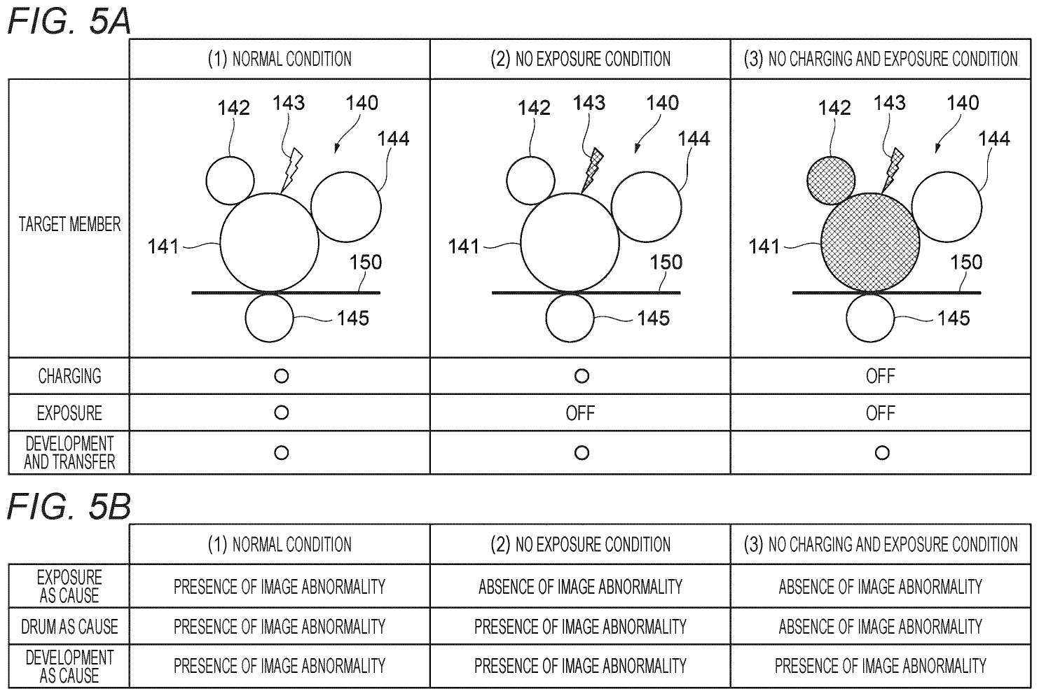

FIGS. 5A and 5B are tables describing the method of identifying a cause of an image abnormality, FIG. 5A illustrates various image forming conditions when the chart paper CP (see FIG. 1) is generated, and FIG. 5B illustrates the identified causes.

The table shown in FIG. 5A lists various image forming conditions for generating the chart paper CP in the image forming apparatus 100. The various image forming conditions include three conditions, namely, (1) normal condition, (2) no exposure condition, and (3) no charging and exposure condition.

Under (1) the normal condition, charging by the charging section 142, exposure by the exposure section 143, and development by the development section 144 are performed on the photosensitive drum 141 in the image forming unit 140. The image developed on the photosensitive drum 141 is transferred to an intermediate transfer belt 150 by the primary transfer section 145.

Under (2) the no exposure condition, only exposure by the exposure section 143 is not performed, and transfer to the intermediate transfer belt 150 is performed.

Under (3) the no charging and exposure condition, only charging by the charging section 142 and exposure by the exposure section 143 are not performed, and transfer to the intermediate transfer belt 150 is performed.

The indication illustrated in FIG. 5B indicates whether an image abnormality occurs under each of “(1) the normal condition”, “(2) the no exposure condition”, and “(3) the no charging and exposure condition”. The exposure, the drum, and the development are specified as a cause by a combination of the presence or absence of occurrence of the image abnormality.

<Case where Cause is Identified as Exposure>

In a case where a streak appears under the normal condition, when the same streak does not appear under neither the no exposure condition nor the no charging and exposure condition, the cause of the streak is identified as exposure by the exposure section 143. That is, the streak is an exposure streak.

<Case where Cause is Identified as Drum>

In a case where a streak appears under the normal condition, when the same streak appears under the no exposure condition but does not appear under the no charging and exposure condition, the cause of the streak is identified as surface deterioration of the photosensitive drum 141. That is, the streak is a drum streak.

<Case where Cause is Identified as Development>

In a case where a streak appears under the normal condition, when the same streak appears under both the no exposure condition and the no charging and exposure condition, the cause of the streak is identified as development by the development section 144. That is, the streak is a development streak.

Next, a functional configuration of the CPU 11a according to the present exemplary embodiment will be described.

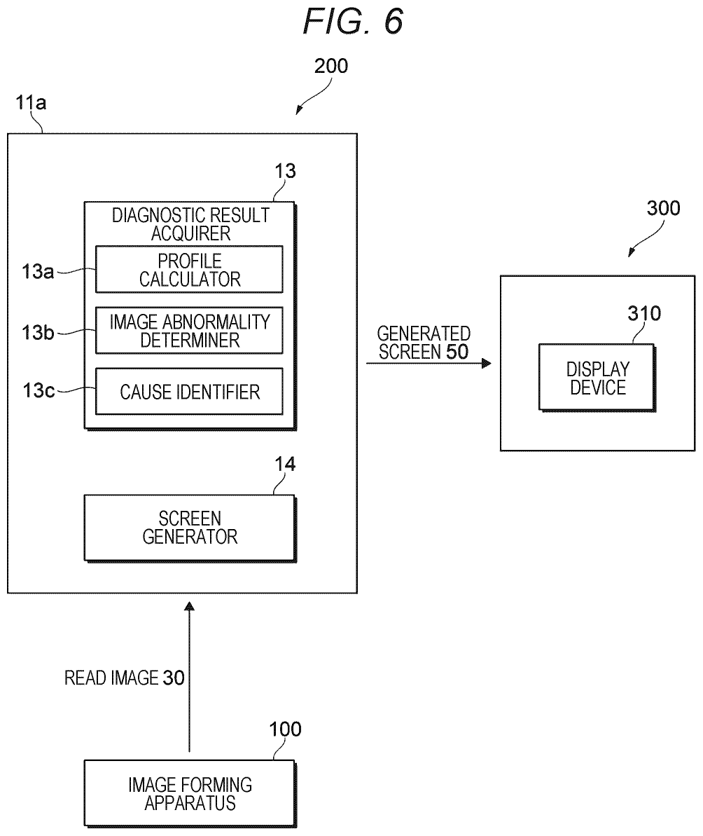

FIG. 6 is a block diagram illustrating the functional configuration of the CPU 11a provided in the server apparatus 200, and also illustrates the image forming apparatus 100 and the user terminals 300 for ease of description.

As illustrated in FIG. 6, the CPU 11a includes a diagnosis result acquirer 13 and a screen generator 14.

### <Diagnosis Result Acquirer 13>

The diagnosis result acquirer 13 acquires a diagnosis result which is a result of diagnosis performed on the read image 30 transmitted from the image forming apparatus 100. The diagnosis is performed for each of diagnosis items determined in advance in accordance with the chart image 61 (see FIG. 1) included in the read image 30. Therefore, the diagnosis result acquirer 13 acquires a diagnosis result for each of the predetermined diagnosis items and performs processing.

Specifically, the diagnosis result acquirer 13 according to the present exemplary embodiment acquires a diagnosis result of a streaky image extending in one direction, which is an image abnormality of the read image 30. The diagnosis result referred to herein includes detection information as to whether a streaky image is generated, and identification information indicating a cause identified when a streaky image is generated.

Note that the streaky image referred to herein is a so-called printer streak generated during image formation.

As illustrated in FIG. 6, the diagnosis result acquirer 13 includes a profile calculator 13a, an image abnormality determiner 13b, and a cause identifier 13c as a configuration for acquiring a diagnosis result of a streaky image by image analysis of the read image 30.

The profile calculator 13a calculates an averaged brightness profile of the read image 30.

The image abnormality determiner 13b detects an image abnormality existing in the read image 30 by using the averaged brightness profile calculated by the profile calculator 13a.

The image abnormality determiner 13b according to the present exemplary embodiment uses the averaged brightness profile calculated by the profile calculator 13a, but it is also conceivable to adopt another method, for example, a method of outputting and reading the chart paper CP (see FIG. 1) under a different condition and determining an image abnormality on the basis of a width and density of a streak. In a case of adopting such a method, a configuration is adopted in which the profile calculator 13a is omitted.

The cause identifier 13c identifies the cause of the detected image abnormality. Such a cause can include a case where the cause is exposure by the exposure section 143 (see FIG. 4) and a case where the cause is surface deterioration of the photosensitive drum 141 (see FIG. 4).

### <Screen Generator 14>

The screen generator 14 generates a screen for notifying the user of the acquired diagnosis result. A generated screen 50 which is a screen having been generated is transmitted from the server apparatus 200 to the user terminal 300, and is displayed on the display device 310 of the user terminal 300 to be notified to the user.

Next, processing by the diagnosis result acquirer 13 (see FIG. 6) will be described in more detail.

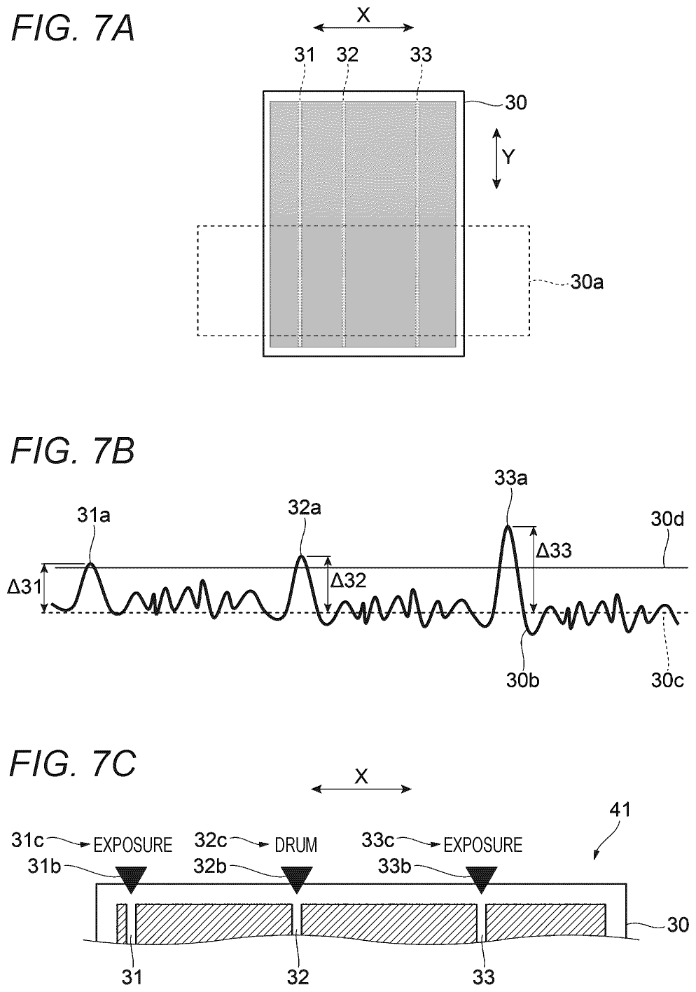

FIGS. 7A to 7C are diagrams for describing the processing by the diagnosis result acquirer 13, FIG. 7A illustrates the read image 30, FIG. 7B illustrates the averaged brightness profile, and FIG. 7C illustrates the diagnosis result. Processing of the profile calculator 13a will be described with reference to FIG. 6A, processing of the image abnormality determiner 13b will be described with reference to FIG. 6B, and a diagnosis result after processing of the cause identifier 13c will be described with reference to FIG. 6C.

For a portion 30a of the read image 30 illustrated in FIG. 7A, the profile calculator 13a (see FIG. 6) calculates and obtains a brightness profile. Such a brightness profile indicates brightness fluctuation in the direction of an arrow X.

To further describe the brightness profile, the brightness profile is an averaged brightness profile 30b (see FIG. 7B) obtained by averaging the brightness in the direction of an arrow Y in the portion 30a. As the calculation of the average, for example, a simple average, a square average, and a weighted average are considered.

In the read image 30 illustrated in FIG. 7A, streaks 31, 32, and 33 extending in the direction of the arrow Y appear. The streaks 31 to 33 are examples of an image abnormality.

For the averaged brightness profile 30b illustrated in FIG. 7B, the image abnormality determiner 13b (see FIG. 6) sets an averaged brightness 30c and a predetermined threshold value 30d.

The averaged brightness profile 30b exemplified in FIG. 7B has vertices 31a, 32a, and 33a. The vertex 31a corresponds to the streak 31, the vertex 32a corresponds to the streak 32, and the vertex 33a corresponds to the streak 33.

All of the vertices 31a to 33a exceed the threshold value 30d. Therefore, the image abnormality determiner 13b determines the vertices 31a to 33a as an image abnormality. The image abnormality is determined focusing on contrast.

By image analysis of the read image 30 illustrated in FIG. 7A, the cause identifier 13c identifies the cause of each of the streaks 31 to 33. Such identification indicates that the streaks 31 and 33 have occurred due to exposure by the exposure section 143 (see FIG. 4), and the streak 32 has occurred due to surface deterioration of the photosensitive drum 141 (see FIG. 4).

Therefore, as illustrated in FIG. 7C, on a result display screen 41 by the screen generator 14, a triangular mark 31b indicating the position of the streak 31 and a character 31 of “exposure” indicating the cause are provided correspondingly to the streak 31 in the read image 30. A triangular mark 1b indicating the position of the streak 32 and a character 32c of “drum” indicating the cause are provided correspondingly to the streak 32. A triangular mark 33b indicating the position of the streak 33 and a character 33c of “exposure” indicating the cause are provided correspondingly to the streak 33. The result display screen 41 referred to herein is one of the generated screens 50 (see FIG. 6).

Here, as illustrated in FIG. 7B, a difference between the vertex 31a and the average brightness 30c is a difference Δ31. A difference between the vertex 32a and the average brightness 30c and a difference between the vertex 33a and the average brightness 30c are differences Δ32 and Δ33, respectively.

Of the differences Δ31 to Δ33, the difference Δ33 of the vertex 33a is the largest, and the difference Δ31 of the vertex 31a is the smallest (431<A32<433). The larger the difference is, the more clearly the image abnormality appears in the read image 30, and the user can recognize the image abnormality more easily. Therefore, the streak 31 corresponding to the vertex 31a is hardly confirmed, and the streak 33 corresponding to the vertex 33a is easily confirmed.

In such a case, with only an indication of the streak 31 as the image abnormality and the exposure as the cause to the user on the result display screen 41, it may be difficult for the user to determine whether the result is reliable. That is, although the cause of the image abnormality can be identified by automatic analysis, the accuracy is assumed to be not high. If the cause is not accurate, it is necessary to visually identify the cause or reacquire a member necessary for coping with the cause, which increases time and effort for the user. In addition, for example, even if a numerical value is indicated, there is a problem that it is difficult for the user to intuitively understand numerical value information alone.

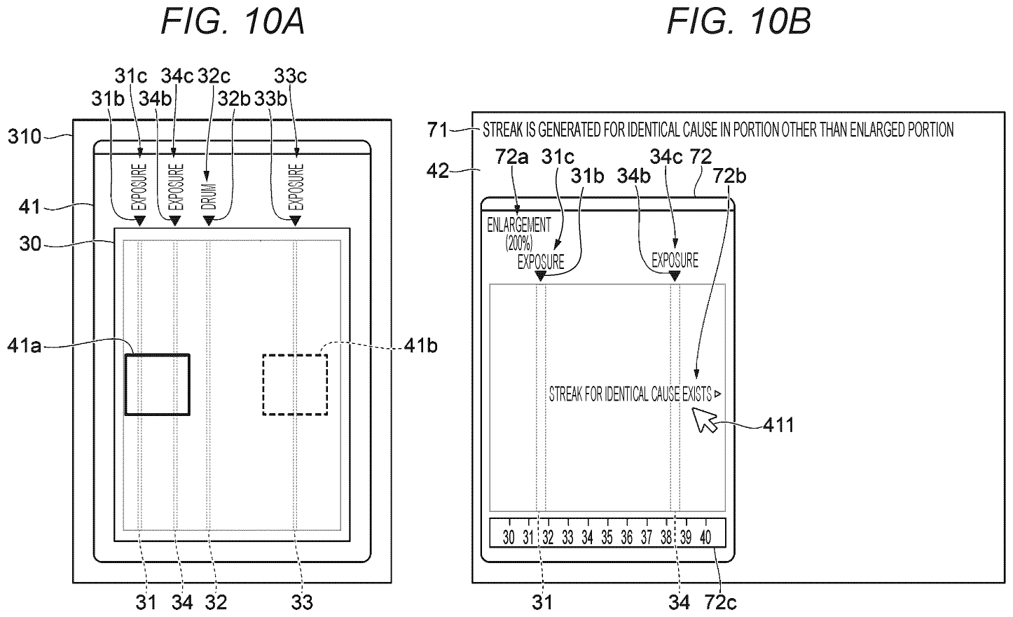

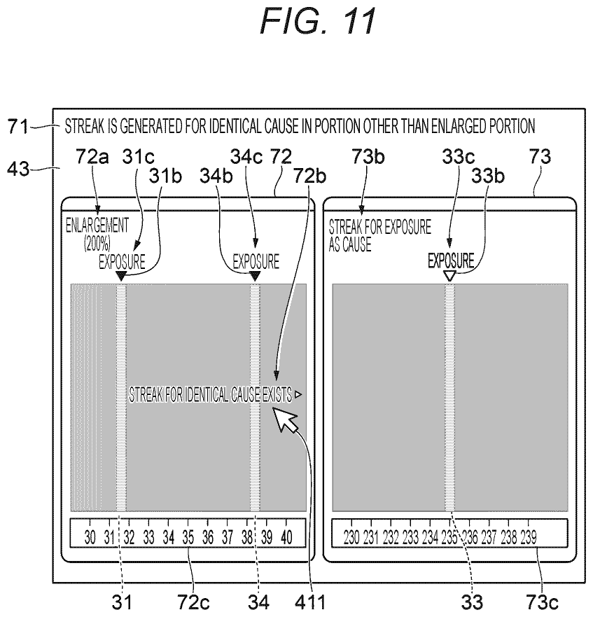

Therefore, in the present exemplary embodiment, when a user's operation on the result display screen 41 is detected, information that is easy to understand intuitively is notified in accordance with the operation. That is, the image abnormality focused by the user is identified through the operation, and notification screens 42 and 43 (for example, see FIGS. 10B and 11) described later, which are screens for presenting other image abnormalities having the same cause as the identified image abnormality, are provided.

Note that in the result display screen 41, the character 31c “exposure” indicating the cause is displayed in association with the streak 31. In the result display screen 41, the character 32c of “drum” indicating the cause is displayed in association with the streak 32, and the character 33c of “exposure” indicating the cause is displayed in association with the streak 33. The result display screen 41 is an example of a display in which the cause of the image abnormality is associated with the image abnormality.

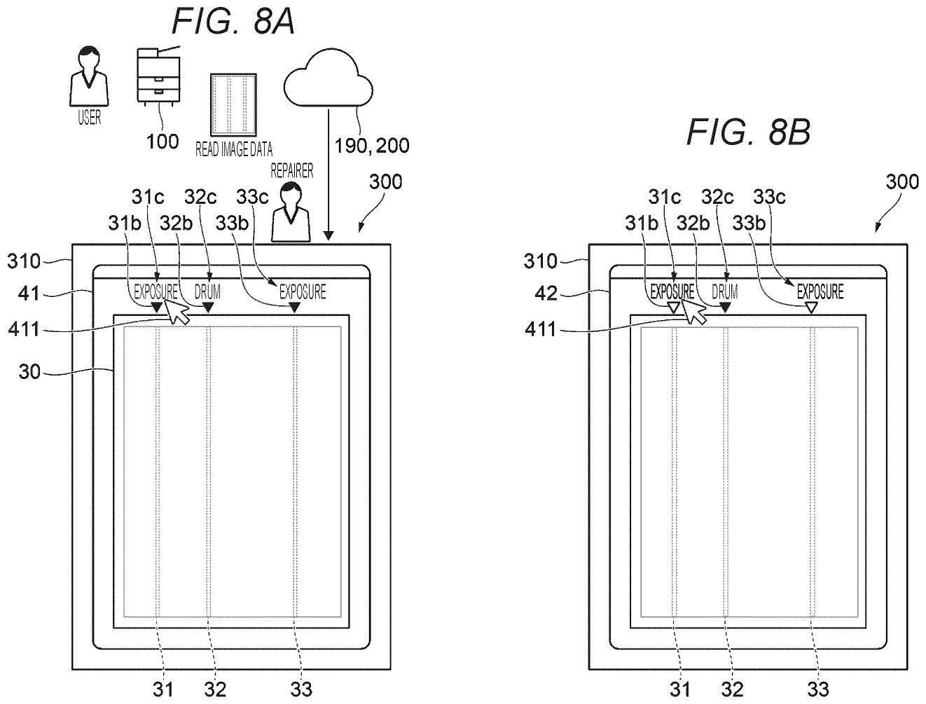

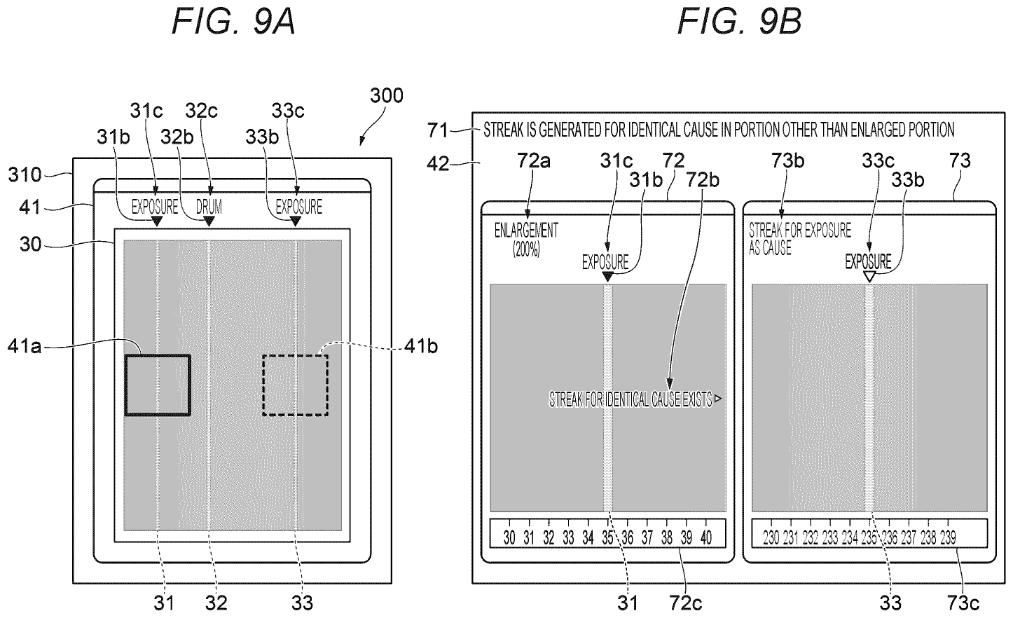

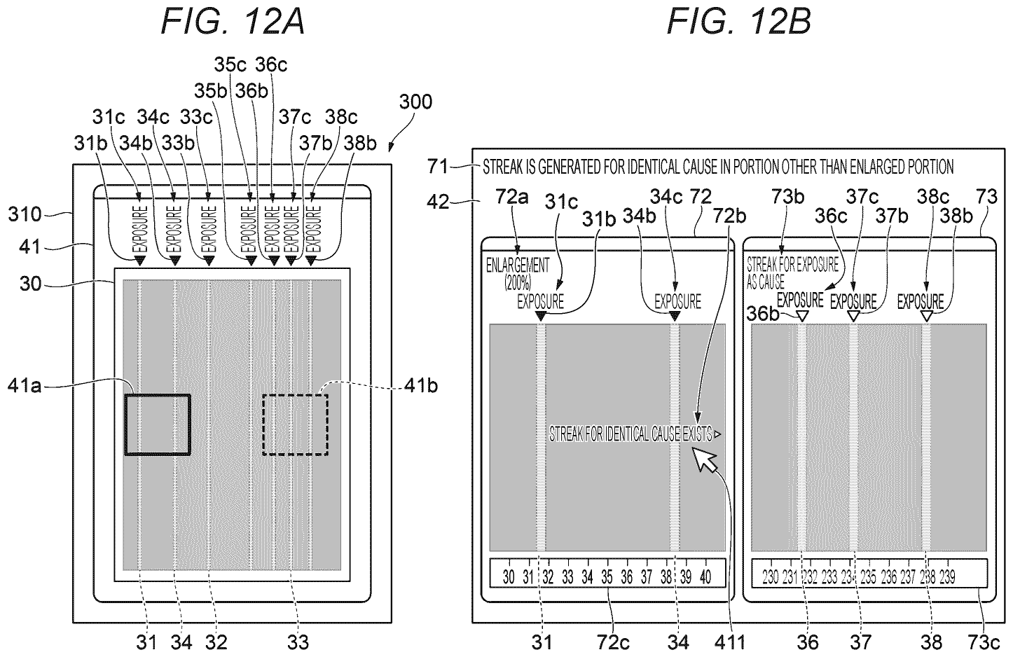

Hereinafter, various exemplary embodiments of the notification screen 42 will be described. A first exemplary embodiment will be described with reference to FIGS. 8A and 8B, and a second exemplary embodiment will be described with reference to FIGS. 9A and 9B. A third exemplary embodiment will be described with reference to FIGS. 10A, 10B, and 11, and a fourth exemplary embodiment will be described with reference to FIGS. 12A and 12B. The notification screen 43 will be described in the third exemplary embodiment.

### First Exemplary Embodiment

Next, display on the display device 310 of the user terminal 300 according to the first exemplary embodiment will be described with reference to FIGS. 8A and 8B.

FIGS. 8A and 8B are diagrams for describing display on the display device 310 of the user terminal 300 according to the first exemplary embodiment, FIG. 8A illustrates a case where the result display screen 41 is displayed on the display device 310, and FIG. 8B illustrates a case where the notification screen 42 is displayed on the display device 310. Note that the result display screen 41 and the notification screen 42 are generated by the screen generator 14 (see FIG. 6).

As illustrated in FIG. 8A, when the server apparatus 200 acquires a diagnosis result on the basis of the read image data of the chart paper CP transmitted from the image forming apparatus 100, the server apparatus 300 generates the result display screen 41. The generated result display screen 41 is displayed on the display device 310 of the user terminal 300.

The result display screen 41 includes the read image 30 and diagnosis results which are the triangular marks 31b to 33b corresponding to the streaks 31 to 33 in the read image 30 and the characters 31c to 33c indicating the causes. The character 31c of “exposure” indicating the cause is provided to the streak 31, the character 32c of “drum” indicating the cause is provided to the streak 32, and the character 33c of “exposure” indicating the cause is provided to the streak 33.

When the user who has confirmed the result display screen 41 designates the character 31c of the streak 31 with a cursor 411 as illustrated in FIG. 8A because the user is concerned about a “white streak at a left end”, that is, the streak 31 of the streaks 31 to 33, the screen is switched from the result display screen 41 to the notification screen 42 on the display device 310. The result display screen 41 and the notification screen 42 are examples of the generated screen 50 (see FIG. 6).

As illustrated in FIG. 8B, on the notification screen 42, a display mode of the triangular mark 31b of the designated streak 31 and the character 31c of “exposure” is changed from a display mode of the result display screen 41 illustrated in FIG. 8A. Furthermore, the same change in the display mode is performed for the streak 33 that is the same cause as the streak 31. That is, the triangular mark 33b and the characters 33c of “exposure” of the streak 33 are the same as the display mode of the streak 31.

As the display mode referred to herein, the triangular marks 31b and 33b are white, and the characters 31c and 33c of “exposure” are bold in FIG. 8B, but the display mode is not limited to this example. Examples of the display mode include color. For example, the color is changed from black to red to call the user's attention.

Note that the display mode of the streak 32 has not been changed on the notification screen 42.

In this manner, on the notification screen 42 according to the first exemplary embodiment, the streak 31 selected by the user with the cursor 411 on the result display screen 41 and the streak 33 having a common cause are highlighted more than the streak 32 having no common cause. The user can compare the widths, densities, and the like of the streaks 31 and 33. In other words, the notification screen 42 can provide information that is easy for the user to intuitively understand. Note that the user who refers to the diagnosis result includes a repairer illustrated in FIG. 8B who has received a repair request from the user, in addition to someone on the user's side.

In the first exemplary embodiment, the character 31c of “exposure” indicating the cause of the streak 31 is an example of the cause of the image abnormality designated by the user, and the streak 33 is an example of another image abnormality having a common cause. The notification screen 42 in which the display mode of the streak 33 is different from the display mode of the result display screen 41 is an example of output of the presence of another image abnormality having a common cause.

### Second Exemplary Embodiment

Next, display on the display device 310 of the user terminal 300 according to the second exemplary embodiment will be described with reference to FIGS. 9A and 9B.

FIGS. 9A and 9B are diagrams for describing display on the display device 310 of the user terminal 300 according to the second exemplary embodiment, FIG. 9A illustrates a case where the result display screen 41 is displayed on the display device 310, and FIG. 9B illustrates a case where the notification screen 42 is displayed on the display device 310. The illustration and description until the user terminal 300 transmits the result display screen 41 and the notification screen 42 are common to the case of the first exemplary embodiment (see FIGS. 8A and 8B), and thus will be omitted. The same applies to the third exemplary embodiment (see FIGS. 10A, 10B, and 11) and the fourth exemplary embodiment (see FIGS. 12A and 12B) which will be described later.

In the read image 30 on the result display screen 41 illustrated in FIG. 9A, the same streaks 31 to 33 as in the first exemplary embodiment (see FIG. 8A) are detected.

As illustrated in FIG. 9A, when a range 41a is designated by an input operation of the user on the result display screen 41 displayed on the display device 310 of the user terminal 300, a streak existing within a range 41a is identified. Since only the streak 31 exists in the designated range 41a, the streak 31 is identified.

In this manner, in the second exemplary embodiment, unlike the first exemplary embodiment (see FIG. 8A) in which the streak 31 is designated by selecting the character 31c of the streak 31 with the cursor 411, the streak 31 is designated by range designation of designating the range 41a including the streak 31. Therefore, in the case of selecting a plurality of streaks including a streak other than the streak 31 in the range 41a, for example, it is considered that a character that prompts the user to designate a range again is additionally displayed on the result display screen 41.

Here, the range 41a designated by the user is an example of a region including an image abnormality in the read image. The presence of only the streak 31 in the designated range 41a is an example of a predetermined condition.

The predetermined condition used herein refers to a condition for identifying one cause of a streak focused on by the user on the basis of the range 41a designated by the user, and examples of the predetermined condition include a case where only one streak is included in the range 41a and a case where a plurality of streaks is included in the range 41a and the causes of the plurality of streaks are common.

When the streak 31 is identified by the range designation of the range 41a, as illustrated in FIG. 9B, the display device 310 is switched from the result display screen 41 to the notification screen 42 which is a different screen.

The notification screen 42 according to the second exemplary embodiment includes a description 71 indicating the presence of the streak 33 having a cause common to the cause of the streak 31, an enlarged display section 72 that enlarges and displays the range 41a including the streak 31, and an enlarged display section 73 that enlarges and displays the range 41b including the streak 33. The enlarged display section 72 and 73 are enlarged and displayed on the left and right sides so that the streak 31 in the enlarged display section 72 and the streak 33 in the enlarged display section 73 can be easily compared with each other. The notification screen 42 is disposed so that the streak 31 and the streak 33 can be easily compared with each other.

In the notification screen 42 according to the second exemplary embodiment, the enlarged display section 72 is an example of a designated region including an image abnormality, and the enlarged display section 73 is an example of a region including another image abnormality.

The description 71 includes characters of “streak is generated for identical cause in portion other than enlarged portion” in the present exemplary embodiment. Thus, the user is notified of the presence of the streak 33 that can be compared with the streak 31.

The enlarged display section 72 includes a display 72a including characters “enlargement (200%)” indicating an enlargement magnification, a display 72b including characters “streak for identical cause exists” for describing the enlarged display section 73 and a rightward symbol indicating that the enlarged display section 73 is on the right side, and a scale 72c indicating the position of the streak 31.

The enlarged display section 73 includes a display 73b “exposure for streak as cause” indicating that the cause of the streak 31 is exposure, and a scale 73c indicating the position of the streak 33 having the same cause as the streak 31. In the second exemplary embodiment, since the enlargement magnification of the enlarged display section 73 is the same as the enlargement magnification of the enlarged display section 72, there is no display corresponding to the display 72a of the enlarged display section 72, but the display may be provided.

To further describe the enlargement magnification, the enlargement magnification of the enlarged display section 72 and the enlargement magnification of the enlarged display section 73 may be the same value or may be different values.

Specifically, it is conceivable to automatically set the enlargement magnification of the enlarged display section 72 in accordance with the size of the range 41a (see FIG. 9A), and display the enlarged display section 73 at the automatically set enlargement magnification. The enlarged display section 73 may perform display at a magnification different from the automatically set enlargement magnification.

Furthermore, it is also conceivable to manually set the enlargement magnification of the enlarged display section 72 and the enlargement magnification of the enlarged display section 73.

The automatic setting and the manual setting of the enlargement magnification here are examples of the setting of the magnification for the read image.

Note that although the example of performing enlarged display has been described in the second exemplary embodiment, it is also conceivable to adopt an example of performing equal-magnification display without performing enlarged display or an example of performing reduced display.

The triangular mark 31b indicating the position of the streak 31 and the character 31c of “exposure” indicating the cause in the enlarged display section 72 and the triangular mark 33b indicating the position of the streak 33 and the character 33c of “exposure” indicating the cause in the enlarged display section 73 are different from each other in display mode. That is, the user's attention is drawn to the streak 33 to be compared with the streak 31 selected by the user more than to the streak 31.

In this manner, on the notification screen 42 according to the second exemplary embodiment, the streak 31 included in the range 41a designated by the user with the cursor (not illustrated) on the result display screen 41 and the streak 33 having a cause common to the cause of the streak 31 are displayed in an enlarged manner. The streaks 31 and 33 are displayed in the enlarged display sections 72 and 73 disposed on the left and right sides on the notification screen 42. The display facilitates comparison of the streaks 31 and 33 and makes it possible to provide information that is easy for the user to intuitively understand.

### Third Exemplary Embodiment

Next, display on the display device 310 of the user terminal 300 according to the third exemplary embodiment will be described with reference to FIGS. 10A, 10B, and 11.

FIGS. 10A and 10B are diagrams for describing display on the display device 310 of the user terminal 300 according to the third exemplary embodiment, FIG. 10A illustrates a case where the result display screen 41 is displayed on the display device 310, and FIG. 10B illustrates a case where the notification screen 42 is displayed on the display device 310. FIG. 11 is a diagram for describing the notification screen 43 that notifies more detailed contents than the notification screen 42 in FIG. 10B.

In the read image 30 of the result display screen 41 illustrated in FIGS. 10A and 10B, a streak 34 is detected in addition to the streaks 31 to 33 according to the first exemplary embodiment (see FIG. 8A). Therefore, the result display screen 41 includes the diagnosis results which are the triangular mark 34b corresponding to the streak 34 in the read image 30 and the character 34c of “exposure” indicating the cause.

As illustrated in FIG. 10A, when the range 41a is designated by an input operation of the user on the result display screen 41, the streaks 31 and 34 are identified as the streaks existing in the range 41a. The identified streaks 31 and 34 have a common cause, and thus the result display screen 41 is switched to the notification screen 42 illustrated in FIG. 10B.

In this manner, the result display screen 41 is switched to the notification screen 42 when only the streaks 31 and 34 having the common cause of “exposure” exist in the designated range 41a. That is, this is when the streaks 31 and 34 having a common cause of “exposure” exist, but the streak 32 having the cause of “drum” other than “exposure” does not exist in the range 41a.

The streak 34 is an example of a different image abnormality. The presence of only the streak 34 in addition to the streak 31 in the designated range 41a is an example of the predetermined condition.

Here, when the causes of the streaks 31 and 34 are not common, the causes cannot be identified as one cause, and therefore, the result display screen 41 is not switched to the notification screen 42. It is conceivable to prompt the user to designate again. That is, although it is allowed to designate a plurality of streaks by the operation on the character 31c with the cursor 411 (see FIG. 8A) or the designation of the range 41a with the cursor (not illustrated) (see FIG. 10A) on the result display screen 41, the result display screen 41 is not switched to the notification screen 42 when the causes of the plurality of streaks are not common.

As illustrated in FIG. 10B, the notification screen 42 includes the description 71 and the enlarged display section 72, as in the second exemplary embodiment (see FIG. 9B). As described above, the enlarged display section 72 displays the range 41a in an enlarged manner.

On the other hand, the notification screen 42 according to the third exemplary embodiment does not include the enlarged display section 73 (see FIG. 9B) included in the notification screen 42 according to the second exemplary embodiment.

To further describe the enlarged display section 72, two streaks 31 and 34 having a common cause are displayed in the enlarged display section 72 according to the third exemplary embodiment. The enlarged display section 72 includes the character 31c and 34c of “exposure” corresponding to the streak 31 and the streak 34, and triangular marks 31b and 34b indicating the positions.

Therefore, the user can compare the widths and the densities of the streak 31 and the streak 34 by the enlarged display section 72 of the notification screen 42.

As illustrated in FIG. 10B, the enlarged display section 72 of the notification screen 42 has the streaks 31 and 34, and also has the display 72b including the characters of “streak for identical cause exists” and a right-pointing symbol indicating that the enlarged display section 73 is located on the right side (see FIG. 11).

For comparison with another streak having a common cause, the user designates the display 72b of the notification screen 42 with the cursor 411, and then, the notification screen 42 is switched to the notification screen 43 illustrated in FIG. 11.

The notification screen 43 illustrated in FIG. 11 is obtained by adding the enlarged display section 73 to the notification screen 42 illustrated in FIG. 10B, and corresponds to the notification screen 42 in the second exemplary embodiment (see FIG. 9B). As a result, the enlarged display section 73 of the notification screen 43 is the same as the enlarged display section 73 in the second exemplary embodiment (see FIG. 9B).

Specifically, the notification screen 43 illustrated in FIG. 11 displays the streaks 31 and 34 of the enlarged display section 72 and the streak 33 of the enlarged display section 73. That is, only the streaks 31, 33, and 34 having a common cause are displayed on the notification screen 43, and the streak 32 having another cause is not displayed. Therefore, the user can compare the widths and the densities of the streaks 31, 33, and 34 by the notification screen 43.

In the third exemplary embodiment, in response to an operation of a cursor (not illustrated) by the user on the result display screen 41, the notification screen 42 illustrated in FIG. 10B shows an outline of the streaks included in the range 41a. In order to display other streaks having a common cause with the streaks included in the range 41a, the other streaks are displayed on the notification screen 43 illustrated in FIG. 11 in response to the operation of the cursor (not shown), and the details of the streaks having the common cause are shown.

In the third exemplary embodiment, such notification screens 42 and 43 are used to perform a notification as designated by the user, but the notification may be applied to the second exemplary embodiment described above or the fourth exemplary embodiment described below.

Here, the notification screen 43 according to the third exemplary embodiment is an example of information that displays at least a part of another image abnormality. The enlarged display section 73 of the notification screen 43 is displayed when an operation is performed on the display 72b of the notification screen 42, and is an example of information displayed when the user designates a display of the at least a part.

### Fourth Exemplary Embodiment

Next, display on the display device 310 of the user terminal 300 according to the fourth exemplary embodiment will be described with reference to FIGS. 12A and 12B.

FIGS. 12A and 12B are diagrams for describing display on the display device 310 of the user terminal 300 according to the fourth exemplary embodiment, FIG. 12A illustrates a case where the result display screen 41 is displayed on the display device 310, and FIG. 12B illustrates a case where the notification screen 42 is displayed on the display device 310.

The streaks 31 and 33 to 38 are detected in the read image 30 of the result display screen 41 illustrated in FIGS. 12A and 12B. The cause of all of the streaks 31 and 33 to 38 is “exposure” and common. Therefore, the result display screen 41 includes the diagnosis result which is the triangular marks 31b and 33b to 38b corresponding to the streaks 31 and 33 to 38 in the read image 30 and the character 31c and 33c to 38c of “exposure” indicating the cause.

As illustrated in FIG. 12A, when the range 41a is designated on the result display screen 41 by an input operation of the user, the streaks 31 and 34 are identified as the streaks existing in the range 41a, and the result display screen 41 is switched to the notification screen 42.

The notification screen 42 includes the description 71 and the enlarged display sections 72 and 73. In this respect, the fourth exemplary embodiment is the same as the second exemplary embodiment (see FIG. 9B).

In the enlarged display section 73, the streaks 36 to 38 other than the streaks 31 and 34 displayed in the enlarged display section 72 of the detected streaks 31 and 33 to 38 are displayed. Such selection of the streaks 36 to 38 is performed in accordance with a predetermined display condition.

The predetermined display condition is considered to be all the streaks not displayed in the enlarged display section 72. When the enlargement magnification of the enlargement display section 73 is the same as the enlargement magnification of the enlarged display section 72, the number of images to be displayed is limited. Therefore, the predetermined display condition is considered to be, for example, an order of contrast of brightness.

Next, processing when enlarged display is performed in the second exemplary embodiment, the third exemplary embodiment, and the fourth exemplary embodiment described above will be described. That is, the enlarged display described herein is a mode implemented in the second exemplary embodiment to the fourth exemplary embodiment described above.

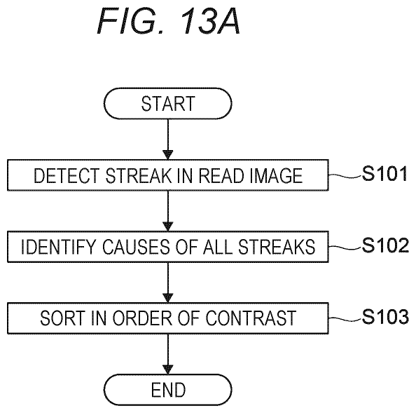

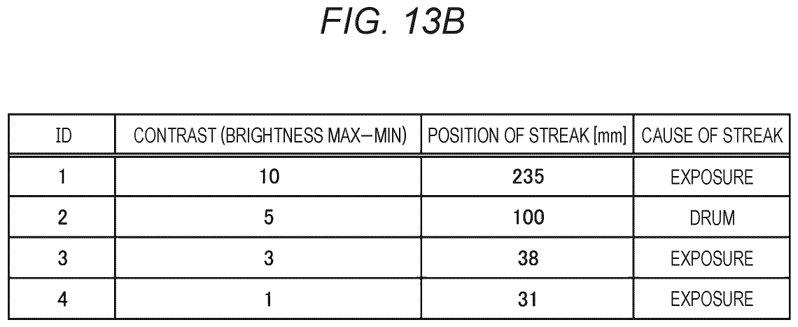

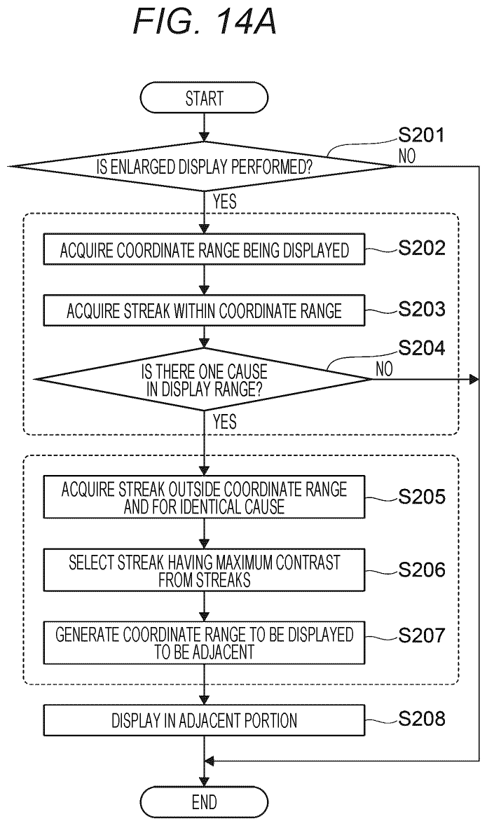

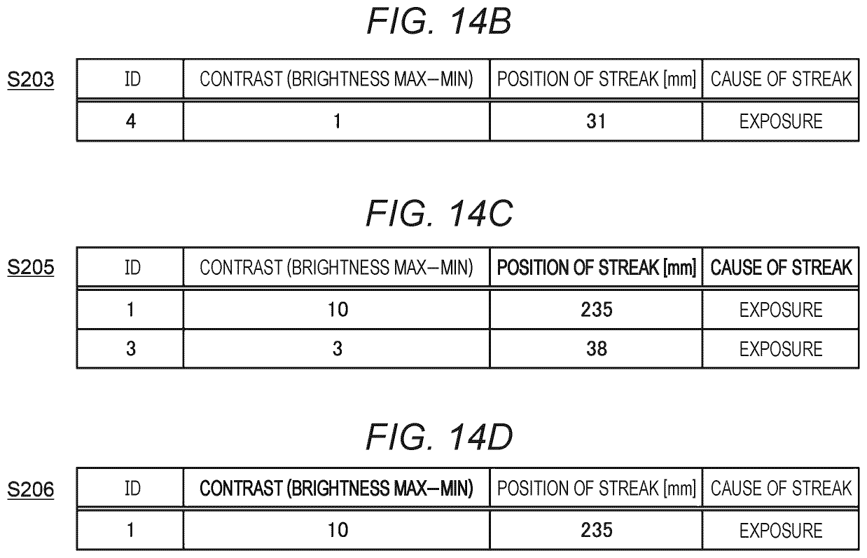

Hereinafter, processing when enlarged display is performed will be described separately as pre-processing and display processing performed after the pre-processing. The pre-processing will be described with reference to FIGS. 13A and 13B, and the display processing will be described with reference to FIGS. 14A to 14D.

FIGS. 13A and 13B are diagrams illustrating the pre-processing, FIG. 13A illustrates an example of a flowchart of processing of creating a contrast table as the pre-processing, and FIG. 13B illustrates an example of the contrast table.

In a processing example illustrated in FIG. 13A, the image abnormality determiner 13b (see FIG. 6) of the diagnosis result acquirer 13 described above detects a streak in the read image 30 on the basis of the averaged brightness profile (see FIG. 7B) by the profile calculator 13a (step 101).

For each detected streak, the diagnosis result acquirer 13 (see FIG. 6) acquires information of “contrast”, which is a difference between a maximum value and a minimum value of the brightness, and the “position of streak”, which indicates the position with respect to the origin (for example, the left end) of the read image 30.

The cause identifier 13c (see FIG. 6) of the diagnosis result acquirer 13 identifies the causes of all the detected streaks by image analysis (step 102). By such identification, the diagnosis result acquirer 13 (see FIG. 6) acquires information of a “cause of streak” which is a cause of a streak for each streak.

Then, each streak is rearranged in the order of contrast based on the “contrast”, that is, sorted (step 103). For example, an ID such as a serial number is given to each streak after sorting. Thus, a contrast table in which information of each of the streaks is arranged in the order of contrast is created.

The contrast table exemplified in FIG. 13B shows the read image 30 (see FIG. 10A) in the third exemplary embodiment described above. The contrast table includes items of ID, contrast, position of streak, and cause of streak, lists information of each streak, and shows streaks of ID1 to ID4. According to the contrast table, the cause of the streaks of ID1, ID3, and ID4 is “exposure”, and the cause of the streak of ID2 is “drum”. Here, the ID1 is the streak 33 (see FIG. 9A) in the third exemplary embodiment, the ID2 is the streak 32 (see FIG. 9A), the ID3 is the streak 34 (see FIG. 9A), and the ID4 is the streak 31 (see FIG. 9A).

FIGS. 14A to 14D are diagrams illustrating the display processing, FIG. 14A is an example of a flowchart of the display processing, and FIGS. 14B to 14D illustrate information acquired or selected in steps in FIG. 14A.

In a processing example illustrated in FIG. 14A, the screen generator 14 (see FIG. 6) determines whether the notification screen 42 (see FIG. 9B, for example) is enlarged and displayed (step 201). As an example of the determination, it is determined that the enlarged display is performed when the range 41a (see FIG. 9A, for example) is designated, and it is determined that the enlarged display is not performed when, for example, the character 31c (see FIG. 8A) of the streak is designated.

When the enlarged display is performed (Yes in step 201), in order to acquire the cause of the streak in an enlargement range which is the range 41a, the screen generator 14 (see FIG. 6) first acquires information indicating a coordinate range being displayed (step 202), and then acquires the streak in the coordinate range (step 203). It is assumed that, unlike in the third exemplary embodiment (see FIG. 10A), a streak within such a coordinate range is only the streak 31 within the range 41a, and is the streak of ID4 as illustrated in FIG. 14B.

Next, the screen generator 14 (see FIG. 6) determines whether the number of causes of the streak acquired in a display range is one (step 204). The cause of the streak of ID4 is “exposure”, and the number of causes is one.

When the number of causes of streak is one (Yes in step 204), the streak, that is, the streak 31 is displayed in the enlarged display section 72 (see FIG. 9B). When the number of causes of streak is not one (No in step 204), the processing ends.

When the enlarged display is not performed (NO in step 201), the processing ends.

When the number of causes of streak is one (Yes in step 204), processing of selecting a display streak to be displayed of streaks outside the coordinate range is performed. That is, a streak outside the coordinate range and having an identical cause is acquired (step 205). The streaks outside the enlargement range are the streaks of ID1, ID2, and ID3, the cause of ID1 and ID3 is “exposure”, and the cause of ID2 is “drum”. Therefore, the streaks selected in step 205 are the streaks of ID1 and ID3 as illustrated in FIG. 14C.

A streak having a maximum contrast is selected from the streaks acquired in step 205 (step 206). Since the streak is the streaks of ID1 and ID3, the contrast of ID1 is ten, and the contrast of ID3 is three. Therefore, the streak selected in step 206 is the streak of ID1 as illustrated in FIG. 14D, and only the streak of ID1 is displayed on the notification screen 42. The notification screen 42 in which only the streak of ID1 is displayed is an example of information that displays any one satisfying a predetermined display condition.

Note that when the number of streaks selected in step 205 is one, the streak selected in step 206 is the same as the streak selected in step 205.

Next, the enlarged display section 73 (see FIG. 9B) which is a coordinate range displayed adjacent to the enlarged display section 72 in the notification screen 42 is generated (step 207), and the streak of ID1, that is, the streak 33 is displayed in the enlarged display section 73 which is an adjacent portion (step 208, see FIG. 9B). Thus, the processing ends.

In this manner, in the present exemplary embodiment, when it is determined that the user has focused on any image abnormality, if another image abnormality having a common cause with the image abnormality focused on exists in the read image 30, the presence of the other image abnormality is notified.

Specifically, when the user selects an image abnormality, if an image abnormality for a common cause exists in the read image 30, the presence of the image abnormality may be displayed. When only a single image abnormality is selected by an enlargement operation by the user, if there is an image abnormality for a common cause outside the enlargement range, the presence of the image abnormality may be displayed. Furthermore, when only an image abnormality for a common cause is selected by an enlargement operation by the user, if there is an image abnormality for a common cause outside the enlargement range, the presence of the image abnormality may be displayed.

### <Supplementary Notes>

(((1))

An information processing system comprising one or a plurality of processors, wherein the one or the plurality of processors acquires a read image that is an image obtained by reading, by a reading section, a diagnosis image of a recording medium output by an image forming section, when the read image has an image abnormality as a result of diagnosis of the read image acquired, displays a cause of the image abnormality in association with the image abnormality, and outputs presence of another image abnormality having the cause being common when at least one of the image abnormality displayed or the cause of the image abnormality is designated by a user.

(((2)))

The information processing system according to (((1))), wherein when the user designates a region including the image abnormality in the read image and the region designated satisfies a predetermined condition, the outputting is performed.

(((3)))

The information processing system according to (((2))), wherein the predetermined condition is presence of only the image abnormality in the region designated.

(((4)))

The information processing system according to (((2))), wherein the predetermined condition is presence of only a different image abnormality having the cause of the image abnormality being common in the region designated.

(((5)))

The information processing system according to any one of (((2))) to (((4))), wherein the outputting is performed by displaying the region designated including the image abnormality and a region including the another image abnormality.

(((6)))

The information processing system according to (((5))), wherein a magnification for the read image is set for the region designated and the region including the another image abnormality.

(((7)))

The information processing system according to any one of (((1))) to (((6))), wherein the presence of the another image abnormality is information that displays at least a part of the another image abnormality.

(((8)))

The information processing system according to (((7))), wherein the information that displays the at least a part of the another image abnormality is displayed when the user designates a display of the at least a part.

(((9)))

The information processing system according to (((7))) or (((8))), wherein when there is a plurality of the another image abnormalities, the information that displays the at least a part of the another image abnormality is information that displays any one of the another image abnormalities satisfying a predetermined display condition.

(((10)))

A non-transitory computer-readable recording medium that stores a program that causes an information processing apparatus to implement an acquisition function of acquiring a read image that is an image obtained by reading, by a reading section, a diagnosis image of a recording medium output by an image forming section, a display function of, when the read image has an image abnormality as a result of diagnosis of the read image acquired by the acquisition function, displaying a cause of the image abnormality in association with the image abnormality, and an output function of, when at least one of the image abnormality or the cause of the image abnormality displayed by the display function is designated by a user, outputting presence of another image abnormality having the cause being common.

What is claimed is:

1. An information processing system comprising one or a plurality of processors,
wherein the one or the plurality of processors acquires a read image that is an image obtained by reading, by a reading section, a diagnosis image of a recording medium output by an image forming section,
when the read image has an image abnormality as a result of diagnosis of the read image acquired, displays a cause of the image abnormality in association with the image abnormality, and
outputs presence of another image abnormality having the cause being common when at least one of the image abnormality displayed or the cause of the image abnormality is designated by a user.

2. The information processing system according to claim 1, wherein when the user designates a region including the image abnormality in the read image and the region designated satisfies a predetermined condition, the outputting is performed.

3. The information processing system according to claim 2, wherein the predetermined condition is presence of only the image abnormality in the region designated.

4. The information processing system according to claim 2, wherein the predetermined condition is presence of only a different image abnormality having the cause of the image abnormality being common in the region designated.

5. The information processing system according to claim 2, wherein the outputting is performed by displaying the region designated including the image abnormality and a region including the another image abnormality.

6. The information processing system according to claim 5, wherein a magnification for the read image is set for the region designated and the region including the another image abnormality.

7. The information processing system according to claim 1, wherein the presence of the another image abnormality is information that displays at least a part of the another image abnormality.

8. The information processing system according to claim 7, wherein the information that displays the at least a part of the another image abnormality is displayed when the user designates a display of the at least a part.

9. The information processing system according to claim 7, wherein when there is a plurality of the another image abnormalities, the information that displays the at least a part of the another image abnormality is information that displays any one of the another image abnormalities satisfying a predetermined display condition.

10. The information processing system according to claim 8, wherein when there is a plurality of the another image abnormalities, the information that displays the at least a part of the another image abnormality is information that displays any one of the another image abnormalities satisfying a predetermined display condition.

11. A non-transitory computer-readable recording medium that stores a program that causes an information processing apparatus to implement
an acquisition function of acquiring a read image that is an image obtained by reading, by a reading section, a diagnosis image of a recording medium output by an image forming section,
a display function of, when the read image has an image abnormality as a result of diagnosis of the read image acquired by the acquisition function, displaying a cause of the image abnormality in association with the image abnormality, and
an output function of, when at least one of the image abnormality or the cause of the image abnormality displayed by the display function is designated by a user, outputting presence of another image abnormality having the cause being common.
